(19) United States
(12) Patent Application Publication
(10) Pub. No.: US 2008/0264329 A1
(43) Pub. Date: Oct. 30, 2008

(54) Dial device and method for manufacturing the same

(75) Inventors: Masahiro ITOH, Ichinomiya-city (JP); Kento UENO, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/081,456

(22) Filed: Apr. 16, 2008

(30) Foreign Application Priority Data
Apr. 27, 2007 (JP) 2007-119310
Jan. 25, 2008 (JP) 2008-14858
Jan. 25, 2008 (JP) 2008-14859

(51) Int. Cl. G09F 9/00

(52) U.S. Cl. 116/311; 29/896.5

(57) ABSTRACT

A dial device includes a dial knob, which is located in a mount hole of a housing and rotatable integrally with a bumpy portion. A plunger as a bottomed hollow member has a tip end, which is configured to engage with the bumpy portion in conjunction with rotation of the dial knob. A coil spring is inserted in an opening rear end of the plunger. A support portion is located in a recess of the housing to support a rear end of the coil spring so as to compress the coil spring to resiliently bias the tip end of the plunger toward the bumpy portion. The plunger is rotatable around the support portion when the tip end is inserted from an outside of the recess into the recess without causing interference between the support portion with the rear end of the plunger.

### CROSS REFERENCE TO RELATED APPLICATIONS

This application is based on and incorporates herein by reference Japanese Patent Applications No. 2007-119310 filed on Apr. 27, 2007, No. 2008-14858 filed on Jan. 25, 2008, and No. 2008-14859 filed on Jan. 25, 2008.

### FIELD OF THE INVENTION

The present invention relates to a dial device. The present invention further relates to a method for manufacturing the dial device.

### BACKGROUND OF THE INVENTION

An operating unit for an equipment, such as an air-conditioning device, a car audio system, and a car navigation system, is provided inside a vehicle such as an automobile. The operating unit has operating devices, which are operated by a passenger on a vehicle at need. For example, as disclosed in JP-A-2006-107904, JP-A-11-7332, JP-A-2001-14977, and JP-U-34437, a dial operating device is frequently adopted for operations of air-conditioning devices such as regulating an air volume, regulating temperature, and selecting a blow-off port. Such a dial operating device is also frequently adopted for manipulating a sound level of car audio systems.

A dial operating device is frequently provided with a click mechanism. In such a click mechanism, as disclosed in JP-A-2006-107904, a click irregularity row is provided on one of a dial knob and a housing, and a click plunger is provided on the other to be resiliently biased toward the click irregularity row. In such a structure, operating angle positions are separately defined to impart an appropriate moderate feeling of click in an operation of the dial operating device.

Various configurations for the click mechanism are proposed. For example, JP-A-2006-107904 and JP-A-11-7332 adopt the procedure of providing a click mechanism mount member, which rotates integrally with a dial knob, separately from the dial knob, mounting a spring and a click plunger to the click mechanism mount member, assembling the dial knob to form an integral dial assembly, and assembling the dial assembly to a housing. On the other hand, JP-A-2001-14977 discloses a construction, in which a housing has an inner peripheral surface defining a dial knob mount hole. The inner peripheral surface of the housing has an opening as a click mechanism mount hole for accommodating both a spring and a click plunger.

With the construction of JP-A-11-7332 and JP-A-2001-14977, however, a click mechanism mount member is required separately from a dial knob, and an increase in the number of parts is unavoidable. On the other hand, the construction of JP-U-34437 has another disadvantage. Specifically, since a click mechanism mount hole is dosed on the side of a dial mount surface, a click plunger and a coil spring need to be pushed and charged into the click mechanism mount hole from an opening on the side of a dial knob mount hole. In addition, it is necessary to mount a dial knob while retaining the click plunger and the coil spring in the click mechanism mount hole, and consequently, assembly of the components becomes difficult.

In addition, when a housing is manufactured by injection molding, a direction, in which a molding core for the dial knob mount hole is pulled out, and a direction, in which a molding core for the click mechanism mount hole is pulled out, do not agree with each other. Accordingly, there is a need for a slide core mechanism, by which the core for the click mechanism mount hole is slid in a different direction from the core for the dial knob mount hole to be pulled out, thus causing a problem that the cost of a molding dies and cores increases. Further, since the slide core needs to be pulled out in a longitudinal direction of the click mechanism mount hole, an inner surface defining the click mechanism mount hole needs a taper at a large angle for pulling out of the core. Thus a problem is caused that rattling of the click plunger in the click mechanism mount hole becomes large and operation noise of the click plunger also becomes conspicuous.

### SUMMARY OF THE INVENTION

In view of the foregoing and other problems, it is an object of the invention to provide a dial device including a click plunger, a coil spring, and a dial knob, which are configured to be readily assembled. It is another object of the invention to provide a method for manufacturing the dial operating device. It is another object of the invention to provide a dial operating device configured to reduce rattling of a component therein.

According to one aspect of the present invention, a dial device comprises a housing having a mount hole and a recess. The dial device further comprises a dial knob rotatable in the mount hole. The dial device further comprises a bumpy portion rotatable integrally with the dial knob and has a bumpy row arranged in a circumferential direction of the dial knob. The dial device further comprises a plunger being a hollow member having a up end and a rear end, the tip end being movable in a movable direction so as to engage with the bumpy row in conjunction with rotation of the dial knob when the plunger is in the recess, the rear end defining an opening. The dial device further comprises a coil spring accommodated in the plunger. The dial device further comprises a support portion located in the recess at a position corresponding to the rear end of the plunger to abut against a rear end of the coil spring. The coil spring is compressed between the support portion and an inner surface of the tip end of the plunger to resiliently bias the plunger toward the bumpy row when the plunger is located in the recess. At least one of the rear end of the plunger and the recess has a shape such that the plunger is configured to be mounted into the recess without causing an interference between the support portion and the rear end of the plunger in a condition where: the plunger is imaginary turned around the support portion as a fulcrum in a turning direction having a turning radius, which corresponds to the movable direction of the plunger, within a predetermined plane so as to direct the up end of the plunger from a first position, in which the tip end is outside the recess, to a second position, in which the tip end is in the recess.

According to another aspect of the present invention, a dial device comprises a housing having a mount hole and a recess. The dial device further comprises a dial knob rotatable in the mount hole. The dial device further comprises a bumpy portion circumferentially extending and rotatable integrally with the dial knob. The dial device further comprises a plunger being a bottomed hollow member having a tip end and an opening rear end, the tip end configured to engage with the bumpy portion in conjunction with rotation of the dial knob when the tip end is in the recess. The dial device further comprises a coil spring inserted in the opening rear end of the plunger and having a rear end located in the opening rear end of the plunger. The dial device further comprises a support portion located in the recess to support a rear end of the coil spring so as to compress the coil spring to resiliently bias the tip end of the plunger toward the bumpy portion. The plunger is rotatable around the support portion when the tip end is inserted from an outside of the recess into the recess without causing interference between the support portion with the rear end of the plunger.

According to another aspect of the present invention, a method for manufacturing a dial device, the method comprises inserting a coil spring into an opening rear end of a plunger to position a rear end of the coil spring in the opening rear end of the plunger. The method further comprises inserting the rear end of the plunger from an outside of a housing into a recess of the housing to abut the rear end of the coil spring against a support portion, which is located in the recess, so as to support the rear end of the coil spring by the support portion. The method further comprises turning the plunger around the support portion to insert the plunger into the recess without causing interference between the support portion with the rear end of the plunger while compressing the coil spring in the plunger by urging the plunger toward the support portion. The method further comprises inserting a dial knob into a mount hole of the housing to engage a tip end of the plunger with a bumpy portion, which is integrated with the dial knob, through a through hole portion.

According to another aspect of the present invention, a dial device comprises a housing molded of resin and having an outer surface, the housing having an inner periphery defining both a mount hole and a recess in the outer surface. The dial device further comprises a dial knob rotatable in the mount hole. The dial device further comprises a bumpy portion rotatable integrally with the dial knob and having an outer peripheral surface defining a bumpy row. The dial device further comprises a plunger having a tip end movable in the recess and configured to engage with the bumpy row in conjunction with rotation of the dial knob. The dial device further comprises a biasing member provided in the recess together with the plunger to resiliently bias the plunger toward the bumpy row. The housing has an inner surface defining the recess formed by drawing a molding core from the recess opening of the recess when the housing is molded of resin. The recess has a length larger than a depth of the recess. The inner surface defining the recess is tapered to have an enlarged width in the recess opening.

### BRIEF DESCRIPTION OF THE DRAWINGS

The above and other objects, features and advantages of the present invention will become more apparent from the following detailed description made with reference to the accompanying drawings. In the drawings:

FIG. 1 is a front view showing an in-vehicle operating unit according to a first embodiment;

FIG. 2A is a plan view showing a dial operating device of the in-vehicle operating unit, and FIG. 2B is a sectional view taken along the line IIB-IIB in FIG. 2A;

FIG. 3 is a perspective view showing the dial operating device according to the first embodiment;

FIG. 4 is a sectional lateral view showing the dial operating device according to the first embodiment;

FIG. 5 is an exploded perspective view showing the dial operating device according to the first embodiment;

FIG. 6 is a sectional view showing manufacturing of the dial operating device according to the first embodiment;

FIG. 7 is a sectional view showing a click plunger of a dial operating device according to an exemplified embodiment;

FIG. 8A is a schematic sectional view showing a molding core and a molding die for forming a tapered surface defining a groove and accommodating the click plunger,

FIG. 8B is a schematic sectional view taken along the line VIIIB-VIIIB in FIG. 8A, and

FIG. 8C is a schematic sectional view taken along the line VIIIC-VIIIC in FIG. 8A;

FIG. 9A is a schematic view showing a spring bearing portion of a click plunger, and FIG. 9B is a sectional view taken along the line IXB-IXB in FIG. 9A, according to a first modification embodiment;

FIG. 10A is a schematic view showing a spring bearing portion of a click plunger, and FIG. 10B is a sectional view taken along the line XB-XB in FIG. 10A, according to a second modification embodiment;

FIG. 11A is a schematic view showing a spring bearing portion of a click plunger, and FIG. 11B is a sectional view taken along the line XIB-XIB in FIG. 11A according to a third modification embodiment;

FIG. 12A is a schematic view showing a spring bearing portion of a click plunger, and FIG. 12B is a sectional view taken along the line XIIB-XIIB in FIG. 12A, according to a fourth modification embodiment;

FIG. 13 is a schematic view showing a tip end floating regulating portion according to an exemplified embodiment; and

FIG. 14 is a schematic view showing a dial operating device according to an exemplified embodiment.

### DETAILED DESCRIPTION OF PREFERRED EMBODIMENTS

### Embodiment

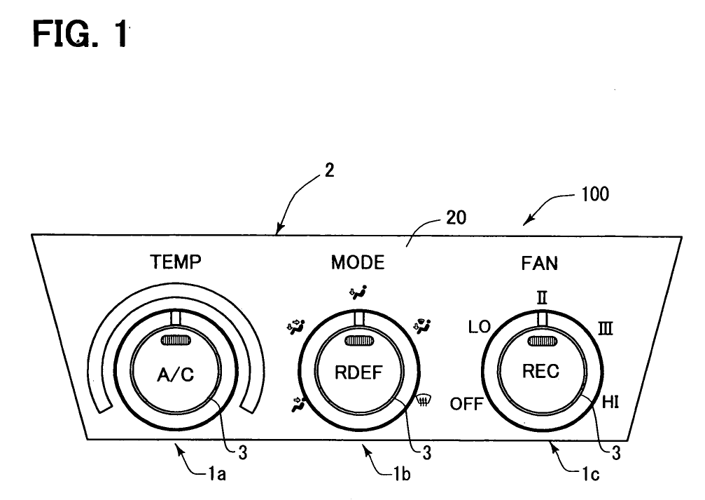

As shown in FIG. 1, an in-vehicle operation unit 100 is provided to operate an automotive air-conditioning apparatus. The in-vehicle operation unit 100 as an in-vehicle electronic equipment includes a housing 2 formed from a resin. Dial operating devices 1a, 1b, 1c are provided on a base surface portion of the housing 2. The base surface portion of the housing 2 defines a front surface of the in-vehicle operation unit 100. Hereinafter, the dial operating devices 1a, 1b, 1c may be typified by the reference numeral “1” when generally specified. The dial operating devices 1a, 1b, 1c, are mounted rotatably on the housing 2 to adjoin in a transverse row of the in-vehicle operation unit 100.

All of the dial operating devices 1a, 1b, 1c are provided for operation of air-conditioning function. The dial operating device 1a is provided as a unit for setting of air-conditioning temperature. The dial operating device 1b is provided as a unit for setting of switchover of an air-conditioning outlet. The dial operating device 1c is provided as a unit for setting of switchover of supply air volume. An angular position, at which a dial knob 3 can be held, of the dial operating device 1a is subdivided further than angular positions of the two remaining dial operating devices 1b, 1c so that temperature setting can be changed semi-continuously. On the other hand, both the dial operating devices 1b, 1c include five angle holding positions arranged at regular angular intervals. The dial operating device 1b for setting of air-conditioning outlet has the five positions including face blow-off, face+feet blow-off, feet blow-off, feet+defroster blow-off, and defroster blow-off. The dial operating device 1c for setting of supply air volume has the five positions including off (stoppage of blow-off), low (air-volume stage I), air-volume stage II, air-volume stage III, and high (air-volume stage IV). The position of the low (air-volume stage I) may be an auto position.

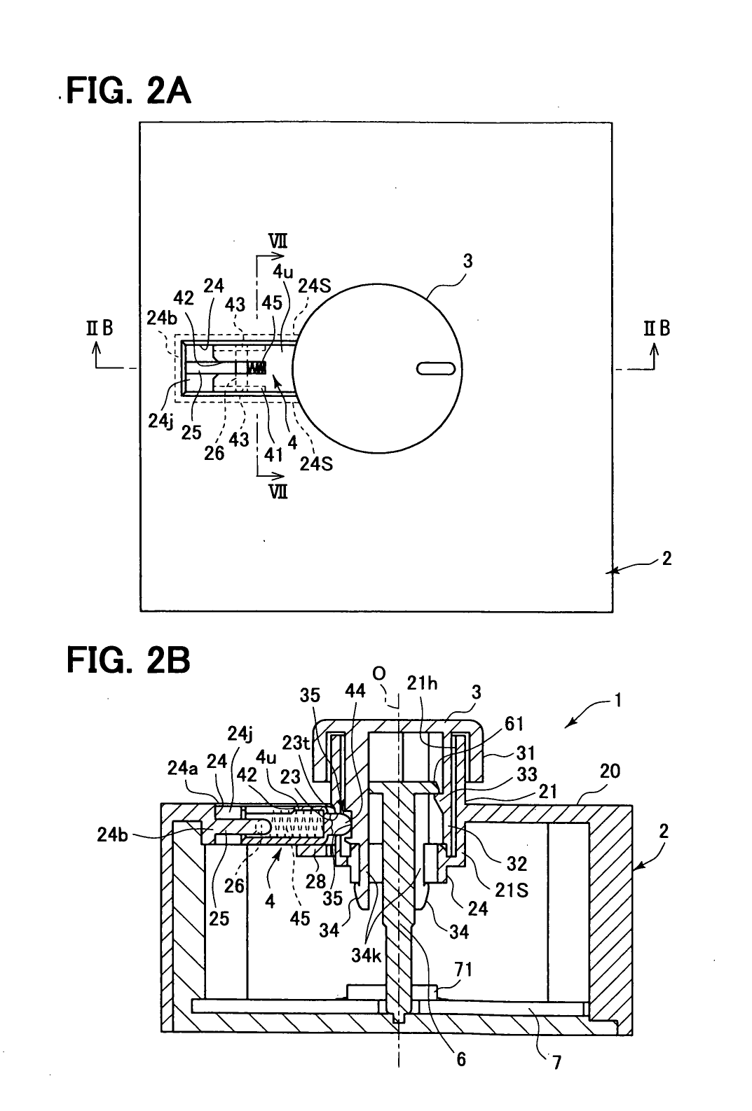

All the dial operating devices 1 have a construction shown in FIGS. 2A, 2B. The housing 2 is constructed as a resin injection molded product, specifically, as an injection molded product of ABS resin, a compound of polycarbonate and ABS resin, or the like. Dial knob mount holes 21h are formed on the surface 20 as a base surface portion 20 of the housing 2 to extend therethrough. The dial knobs 3 are mounted to the dial knob mount holes 21h. The dial knobs 3 are rotatable respectively about rotation axes O, which intersect the base surface portion 20. Bumpy portions 32 are provided on the dial knobs 3 to rotate integrally. The bumpy portions 32 are in positions dented from the base surface portion 20. The Bumpy portions 32 respectively have outer peripheral surfaces each defining a click bumpy row 35.

In addition, the housing 2 is formed with plunger mount grooves 24 as plunger mount recesses, which respectively have openings 24a on the base surface portion 20. Click plungers 4 together with resilient members (biasing member) 45 are mounted in the plunger mount grooves 24 so as to be transversely arranged when being viewed from the rotation axes O with tip ends 44 opposed to the outer peripheral surfaces of the bumpy portions 32. The click plungers 4 are resiliently biased toward the outer peripheral surfaces of the bumpy portions 32 by the resilient members 45 and biased to advance and retreat in the plunger mount grooves 24 in conjunction with the operation to rotate the click bumpy row 35 as the dial knobs 3.

The plunger mount grooves 24 are larger in length than in depth and have an inner surface shape, which allows molding cores for the plunger mount grooves 24 to be pulled out of the openings of the grooves. As shown in FIGS. 8A, 8B, 8C, at least one inner sides of the plunger mount grooves 24 in a width direction define tapered surfaces 24t. The tapered surfaces 24t are formed such that the widths are enlarged on the openings of the grooves. A side 4s of the click plunger 4 opposed to an inner side of the tapered surface 24t of the plunger mount recess 24 in the plunger mount recess 24 defines a steeper surface, which is steeper than the tapered inner side of the plunger mount recess 24 and the click plunger 4. The steeper surface of the click plunger 4 defines a surface not tapered or tapered to have a smaller taper thickness than a taper thickness δ of the tapered surface 24t. The click plunger 4 is clearance fitted in the plunger mount recess 24.

The resilient members 45 include coil springs 45. In addition, the click plunger 4 includes a hollow member opened at a rear end thereof and a spring bearing portion 26. The spring bearing portion 26 is formed in a position corresponding to the rear end in the plunger mount recess 24. Each coil spring 45 is accommodated in the click plunger 4, and the click plunger 4 is mounted in the plunger mount recess 24 in a state, in which the coil spring 45 is compressed between the spring bearing portion 26 and an inner surface tip end of the click plunger 4.

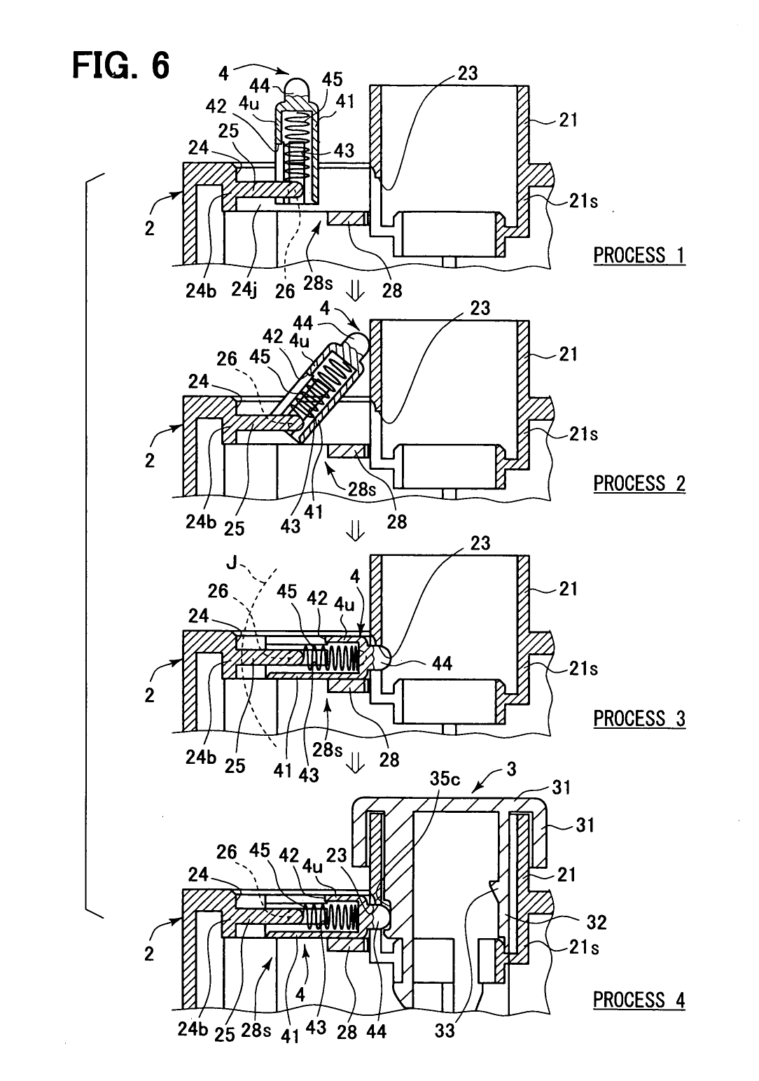

As shown in FIG. 6, the spring bearing portion 26 is defined as a turning fulcrum of the click plunger 4. The direction, in which the click plunger 4 advances and retreats, is defined as a direction of turning radius. A rear end of the click plunger 4 and the plunger mount recess 24 as a recess are shaped so that the spring bearing portion 26 and the rear end of the click plunger 4 does not substantially interfere with each other when the click plunger 4 is turned about the spring bearing portion 26 in a predetermined plane from a first position toward a second position. In the first position as the position in the process 1, the tip end of the click plunger 4 is positioned outside the plunger mount recess 24. In the second position as the position in the process 4, the tip end of the click plunger 4 is positioned inside the plunger mount recess 24.

As shown in FIGS. 2A, 2B, the click plunger 4 is formed with plunger side guide engagements (plunger guide portion) 43, 43, which are opened to the rear end surface of the click plunger 4 and extended in a direction, in which the click plunger 4 advances and retreats. The spring bearing portion 26 also functions as a plunger guide portion 26, which engages with the plunger side guide engagements 43, 43 of the click plunger 4 from an opened side to guide advancing and retreating movements of the click plunger 4.

Specifically, the spring bearing portion 26 as the plunger guide portion 26 includes a guide projection 26 as the groove side engagement, which protrudes from the inner surface defining the plunger mount recess 24. In addition, the plunger side guide engagements 43, 43 as the plunger side engagements 43, 43 are opened in the plunger rear end surface and formed in a manner to cut to an intermediate position in a longitudinal direction of the click plunger 4 toward the plunger tip end.

The plunger side engagements 43, 43 receive the guide projection 26 from the plunger rear end surface side in the plunger longitudinal direction to thereby guide advancing and retreating movements of the click plunger 4 for a predetermined length in the plunger mount recess 24.

The plunger side engagements 43, 43 include guide slits (guide notch) 43, 43 formed on the wall portion of the hollow click plunger 4 to extend therethrough. The guide projection 26 is inserted into the guide slits 43, 43 such that a tip end thereof projects into the click plunger 4, and abuts against a rear end of the coil spring 45 accommodated in the hollow member. The guide projection 26 includes a guide shaft portion 26 arranged in a direction intersecting that direction, in which the click plunger 4 advances and retreats. The guide shaft portion 26 is arranged in the guide slits 43, 43. The guide shaft portion 26 has a smaller width than the width of the guide slits 43, 43.

In addition, an auxiliary shaft portion 25 is provided transversely to a plunger mount clearance 24j in the plunger mount recess 24 in the movable direction, in which the click plunger 4 advances and retreats. The auxiliary shaft portion 25 connects the guide shaft portion 26 with the rear end inner wall portion of the plunger mount recess 24. An auxiliary slit 42, which permits the auxiliary shaft portion 25 to pass therethrough, is formed at the rear end of the click plunger 4 to be positioned to overlap a relative turning locus of the auxiliary shaft portion 25 at the time of imaginary turning. The auxiliary shaft portion 25 is formed to have a smaller width than the width of the auxiliary slit 42.

As shown in FIG. 6, the click plunger 4 is retreated against the resilient bias of the coil spring 45 for a distance sufficient not to cause the tip end 44 of the click plunger 4 to interfere with the click bumpy row 35. In this state, the click plunger 4 is imaginarily turned about a center axis of the guide shaft. In the present condition, a recess rear end wall 24b defining the rear end of the plunger mount recess 24 is located at the position with respect to the movable direction of the click plunger 4, and the position is determined rearward of an imaginary locus J drawn by a rear end of the click plunger 4. The imaginary locus J is indicated by a broken line in the process 3.

In addition, a bottom rear portion of the plunger mount recess 24 is cut out to be a through hole in order to restrict interference with the imaginary locus J. Here, the plunger mount recess 24 may not be a through hole, and the plunger mount recess 24 may be a bottomed groove having a depth sufficient to restrict interference.

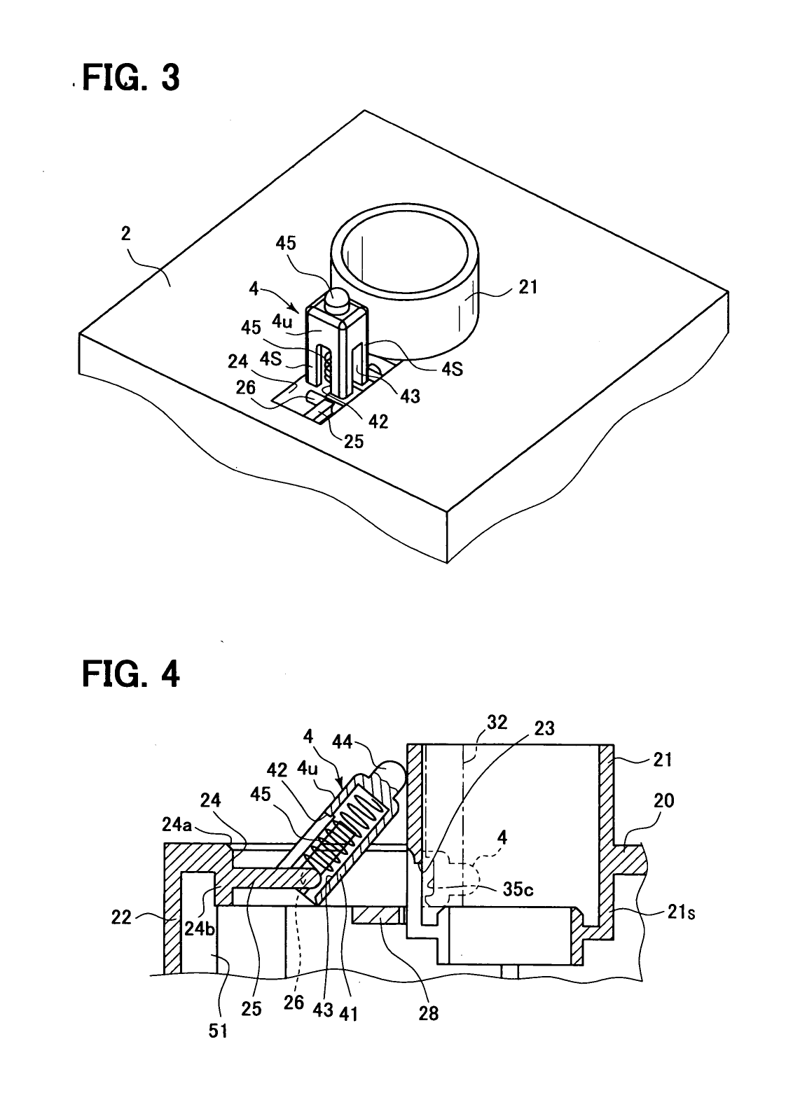

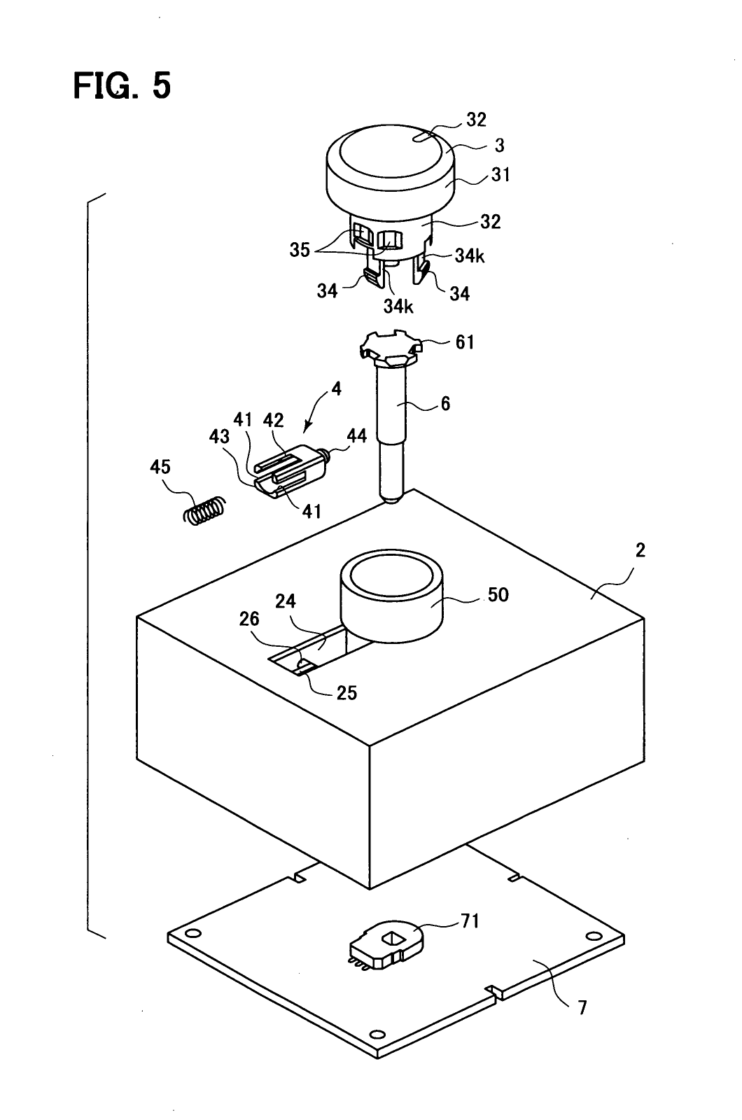

As shown in FIG. 5, the dial knob 3 includes a knob body 31 formed in a capped manner. A knob mount cylinder portion 21 protrudes on a surface of the base surface portion 20 of the housing 2 as shown in FIG. 3 and the knob body 31 is mounted to the knob mount cylinder portion 21 in a manner to cover the knob mount cylinder portion 21 from the outside as shown in FIGS. 2A, 2B. An inner peripheral surface of the knob mount cylinder portion 21 defines the dial knob mount holes 21h.

In a condition in FIG. 4, the coil spring 45 is accommodated in the plunger mount recess 24 in a state of abutting against the spring bearing portion 26 in a manner not to be compressed. In the present condition, a length of the click plunger 4 in its advancing and retreating direction is determined so that the tip end 44 enters a predetermined length inside the bottoms of recesses 35c of the click bumpy row 35.

As shown in FIGS. 2A, 2B, a direction perpendicular to both a depth direction of the plunger mount recess 24 and the advancing and retreating direction of the click plunger 4 is defined as a width direction of the plunger mount recess 24. In this case, the spring bearing portion 26 also serves as the guide shaft portion 26 formed in a manner to connect between both inner wall portions 24t, 24t of the plunger mount recess 24 in the width direction. The guide slits 43, 43 are formed on the rear end side of the click plunger 4 to define guide shaft engagements, which engage rotatably with the guide shaft portion 26.

The guide slits 43, 43 (guide shaft engagements) are formed in intermediate positions in a height direction of both the widthwise wall portions 4s of the click plunger 4. A plunger mount clearance 24j is formed between the guide shaft portion 26 and the rear end inner wall portion 24b of the plunger mount recess 24. The plunger mount clearance 24j receives those portions of both the widthwise wall portions 4s, which are positioned rearward of the guide slits 43, 43, when the rear end of the click plunger 4 is mounted in a state of being upright in the plunger mount recess 24. In addition, the auxiliary shaft portion 25 is formed transversely to the plunger mount clearance 24j in the plunger mount recess 24. The auxiliary shaft portion 25 extends in the advancing and retreating direction of the click plunger 4 to connect the guide shaft portion 26 with the rear end inner wall portion 24b of the plunger mount recess 24.

A stem portion 32 being inserted inside the knob mount cylinder portion 21 protrudes on a back surface of the top surface portion of the knob body 31 to extend rearward of a rear end of the knob body 31 in a direction of the rotation axis O. The click bumpy row 35 described above is formed on an outer peripheral surface of that portion of the stem portion 32, which extends from a rear end of the knob body 31, to be positioned corresponding to the plunger mount recess 24 in a state, in which the dial knob 3 is mounted to the knob mount cylinder portion 21. That is, the portion of the stem portion 32 constitutes a bumpy portion.

The knob mount cylinder portion 21 includes a back surface cylinder portion 21s projecting from a back surface of the base surface portion 20. A housing side engagement 24 is formed coaxially at a rear end of the back surface cylinder portion 21s to define a cylinder portion having a smaller diameter than that of the back surface cylinder portion 21s and a pawl-shaped knob side engagement 34 formed at a rear end of the stem portion 32 engages with the stem portion 32 in a manner permitting to rotate about the rotation axis O. A through hole portion 23 is formed on that portion of the back surface cylinder portion 21s, which defines a front end surface of the plunger mount recess 24, to permit the tip end 44 of the click plunger 4 to project toward the click bumpy row 35 formed on the stem portion 32.

The through hole portion 23 (inner peripheral end thereof) defines a tip end floating regulating portion and regulates the tip end of the click plunger 4, which is caused by the resilient bias of the coil spring 45 to abut against the click bumpy row 35 in the plunger mount recess 24, from floating from the recess opening. As apparent from the figure, a position of the through hole portion 23 as the tip end floating regulating portion is determined so that the click plunger 4 can be released from a regulated state by compressing and retreating the click plunger 4 for a predetermined distance against the resilient bias of the coil spring 45 in the plunger mount recess 24. Specifically, in the regulated state, the tip end of the click plunger 4 and the inner peripheral surface of the through hole portion 23 overlap one another in projection onto a plane, which is perpendicular to a depth direction of the plunger mount recess 24. The depth direction corresponds to the direction along the center axis of the dial knob mount hole 21h. On the other hand, in a non-regulated state, in which the click plunger 4 is retreated for a predetermined distance, the tip end of the click plunger 4 and the inner peripheral surface of the through hole portion 23 do not overlap one another.

Furthermore, the guide shaft portion 26 in the plunger mount recess 24 functions as a rear end regulating portion. Specifically, the guide shaft portion 26 engages with the guide slits 43, 43 to regulate the rear end side of the click plunger 4 from floating from the recess opening while permitting the click plunger 4 to advance and retreat for a predetermined distance in the plunger mount recess 24. In addition, a bottom surface of the plunger mount recess 24 and a bottom surface of the click plunger 4, respectively, are defined by flat surfaces, which do not make concave-convex engagement with each other. That is, the bottom surface of the plunger mount recess 24 and the bottom surface of the click plunger 4 are substantially flat and are configured to be tightly in contact with each other. In addition, as shown in FIG. 5, the stem portion 32 of the dial knob 3 is formed to be hollow and fits a rotation detecting rotor 6 thereinto. As shown in FIGS. 2A, 2B, a plurality of engagement pawls 33 are formed circumferentially to protrude from an inner peripheral surface of the stem portion 32. An engagement flange 61 integrally formed with a front end of a rotor 6, which is pushed into the stem portion 32, engages with the engagement pawls whereby the dial knob 3 and the rotor 6 are integrally rotatable. A base plate 7, to which a rotation sensor 71 is mounted, is fixed to a bottom of the housing 2 by screwing or the like. A rear end of the rotor 6 formed with a rotation detected portion is inserted into the rotation sensor 71 to detect the rotational displacement of the dial knob 3.

A procedure of assembling the click plunger 4 to the housing 2 on the dial operating device is described as follows. First, as shown in the process 1 of FIG. 6, the rear end of the click plunger 4 with the coil spring 45 accommodated therein is inserted into the plunger mount recess 24 while the spring bearing portion 26 abuts against and supports the rear end of the coil spring 45. Subsequently, as shown in the process 2, in this state, the click plunger 4 is forcedly inserted into the plunger mount recess 24 by being turned around the spring bearing portion 26 as a fulcrum of turning. As shown in FIG. 4, a length of the click plunger 4 in the advancing and retreating direction is determined in a state, in which the coil spring 45 is not compressed. Therefore, the tip end 44 formed to be semi-spherical in shape first abuts against a side of the knob mount cylinder portion 21 before the click plunger 4 sinks into the plunger mount recess 24.

Referring to FIG. 6, the click plunger 4 is further forcedly inserted into the plunger mount recess 24. In the present condition, the coil spring 45 in the click plunger 4 is compressed between the plunger mount groove and the spring bearing portion 26 and turns toward the plunger mount recess 24 such that the tip end 44 of the click plunger 4 slides on the outer peripheral surface of the dial knob 3. The coil spring 45 is regulated with respect to a length in a non-compressed state. In the non-compressed state, the rear end of the coil spring 45 is extended rearward of bottom positions of the guide slits 43, 43 in a state, in which the tip end of the coil spring 45 abuts against an inner tip end surface of the click plunger 4.

When the click plunger 4 is to be mounted to the plunger mount recess 24, the guide shaft portion 26 is inserted into the guide slits 43, 43 and the rear end of the click plunger 4 is inserted into the plunger mount recess 24 while the coil spring 45 extending into the guide slits 43, 43 is compressed by the guide shaft portion 26. The click plunger 4 is mounted rotationally into the plunger mount recess 24 such that inner ends of the guide slits 43, 43 are rotationally supported on the guide shaft portion 26. Even when a reaction force of the compressed coil spring 45 is exerted to cause the click plunger 4 to jump from the plunger mount recess 24, the guide shaft portion 26 is fitted into the guide slits 43, 43 to restrict such jumping.

In addition, a rear portion of a bottom 28 of the plunger mount recess 24 is cut out to be a through hole whereby a space 28s is ensured to define a margin for rotation of the rear end of the click plunger 4 when the click plunger 4 is rotationally mounted. As indicated by a broken line in the process 3 of FIG. 6, as the guide shaft portion 26 is deeply inserted into the guide slits 43, 43, the rear end of the click plunger 4 is further located rearward with respect to the guide shaft portion 26. Accordingly, the radius of turning is increased, and consequently, the rear end of the click plunger 4 may interfere with the bottom of the plunger mount recess 24. By contrast, in the present structure, the space 28s is formed to restrict such interference between the rear end of the click plunger 4 and the bottom of the plunger mount recess 24.

As shown in the process 3, the coil spring 45 is resiliently restored simultaneously when the tip end 44 of the click plunger 4 is fitted into the plunger mount recess 24. The tip end 44 of the click plunger 4 is then moved to an engagement position, that is, moved into the through hole portion 23 to be projected into the knob mount cylinder portion 21. Thereafter, as shown in the process 4, the stem portion 32 of the dial knob 3 is fitted inside the knob mount cylinder portion 21 whereby assembling is completed.

After the assembling, the guide shaft portion 26 is movable relatively in the guide slits 43, 43. The advancing and retreating movements of the click plunger 4 in conjunction with the operation of the dial knob 3 are guided to enable restricting rattling in a depth direction of the plunger mount recess 24.

That is, as shown in FIGS. 3 and 4, the plunger mount recess 24 is opened toward the dial mount surface as the base surface portion 20 of the housing 2. The click plunger 4 and the resilient member 45 can be simply mounted from an opening 24a in a direction of the rotation axis O of the dial knob 3. In the present structure, the click plunger 4 and the resilient member 45 need not be mounted from an inner peripheral surface side of the dial knob mount hole 21h.

After the assembling, the guide shaft portion 26 is moved relatively in the guide slits 43, 43 whereby advancing and retreating movements of the click plunger 4, which accompany the operation of the dial knob 3, are guided to enable restricting rattling in the depth direction of the plunger mount recess 24.

As shown in FIGS. 8A, 8B, 8C, in injection molding of the housing 2, molding cores 101, 102 for forming the plunger mount recess 24 can be pulled out from a molded product in the direction of the rotation axis O (FIG. 2B) of the dial knob 3. In addition, a molding core 103 for forming the dial knob mount hole 21h extending through the base surface portion 20 of the housing 2 can be also pulled out from a molded product in the direction of the rotation axis O (FIG. 2B) of the dial knob 3, similarly to the molding cores 101, 102. In the present forming, a parting line defined by the molding cores 101, 102 is located at a position, in which the spring bearing portion 26 is divided vertically into two halves, with respect to the depth direction of the plunger mount recess 24. In addition, an inner peripheral surface defining the plunger mount recess 24, the recess opening, and the through-hole on the bottom side of the plunger mount recess 24 are defined by peripheral sides of the molding cores 101, 102. Thus, the inner peripheral surface of the plunger mount recess 24, the recess opening, and the through-hole do not have any molded portion projecting into the groove.

Thereby, a direction, in which the molding core 103 for the dial knob mount hole 21h is pulled out, and a direction, in which the molding cores 101, 102 for the plunger mount recess 24 are pulled out, agree with each other. In addition, in the slide core mechanism of the present structure, the cores for the plunger mount recess 24 need not be slid in a different direction from a direction of the core for the dial knob mount hole 21h when being pulled from the molded product. Thus, a cost for the molding apparatus can be reduced.

In the present embodiment, the molding cores for the plunger mount recess 24 are pulled out in a direction perpendicular to the advancing and retreating direction (movable direction) of the click plunger 4. Therefore, a stroke of the molding cores when being pulled out of the molded product can be reduced. Thus, as shown in FIGS. 8B, 8C, a taper 6 of the inner surface defining the plunger mount recess 24 can be reduced, so that rattling of the click plunger 4 in the click mechanism mount hole can be reduced, and hence operation sound of the click plunger 4 can be also reduced. Both the inner wall portions 24t, 24t of the plunger mount recess 24 in the width direction can be formed as steep wall portions. The side wall portions 4s, 4s of the click plunger 4 can be also formed as steep wall portions. In this case, the click plunger 4 can be tightly clearance fitted in the plunger mount recess 24.

Various modification examples will be described below. FIGS. 9A to 12B show various modifications of a spring bearing portion. In an example shown in FIGS. 9A, 9B, an auxiliary shaft portion is omitted and only a guide shaft portion 26 is provided. In addition, any auxiliary slit is not formed on the click plunger 4. In an example shown in FIGS. 10A, 10B, the guide shaft portion 26 is divided intermediately in the width direction to be two guide projections, which respectively project from the inner sides defining the plunger mount recess 24.

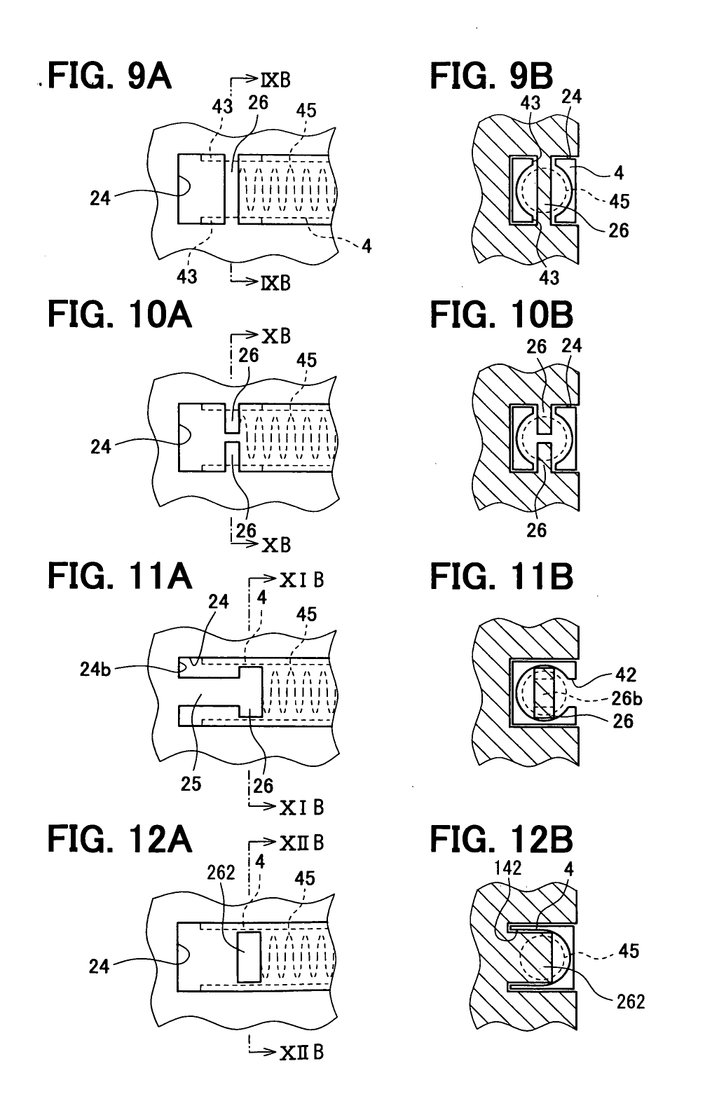

In the construction shown in FIGS. 11A, 11B, the guide shaft portion 26 is not connected to both the inner sides defining the plunger mount recess 24. Clearances are defined between both ends of the guide shaft portion 26 and inner sides of the plunger mount recess 24 with respect to the width direction. A wall portion of the hollow click plunger 4 is able to advance and retreat. In other words, the guide shaft portion 26 together with an auxiliary shaft portion 25 is inserted into an interior of the click plunger 4 from a rear end opening thereof. In the present structure, the guide slit may not be formed on a wall portion of the click plunger 4.

In addition, in a construction shown in FIGS. 12A, 12B, a spring bearing portion 262 is provided upright on a bottom surface of the plunger mount recess 24. The spring bearing portion 262 and both sides of the plunger mount recess 24 therebetween define clearances to permit a wall portion of the hollow click plunger 4 to advance and retreat. The spring bearing portion 262 defines a groove side engagement (guide projection). The spring bearing portion 262 is inserted into an interior of the click plunger 4 from the rear end opening thereof. In addition, guide slits 142 (plunger side engagements) are formed on a bottom wall portion of the click plunger 4 to receive a projecting base end of the spring bearing portion 262.

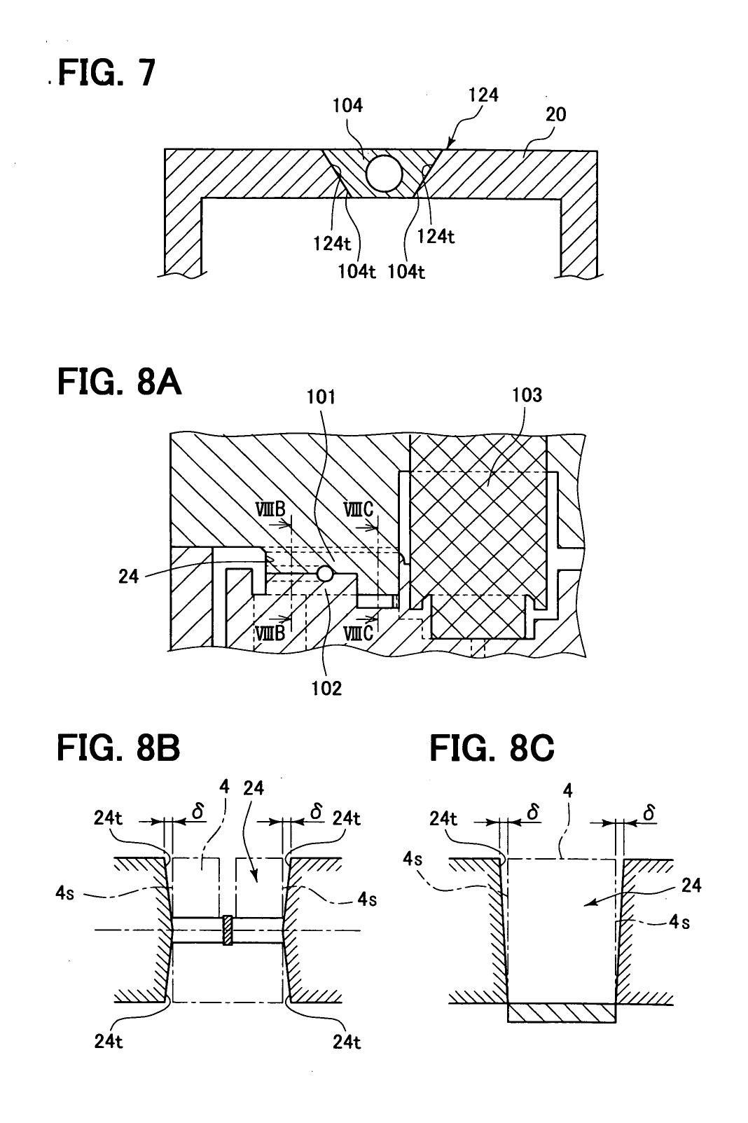

As shown in FIG. 7, at least one, here, both of inner wall portions 124t, 104t of the plunger mount recess 24 in a width direction can be formed as tapered wall portions. The tapered wall portions is defined such that a recess 124 becomes small in width toward the bottom of the recess 124, together with corresponding side wall portions 104t, 104t of the click plunger 4. The tapered wall portions are formed whereby the side wall portions 4s of the click plunger 4 and the inner wall portions 24t, 24t of the plunger mount recess 24 can be fitted together in a slidable manner, thus enabling further decreasing rattling of the click plunger 4 in the width direction.

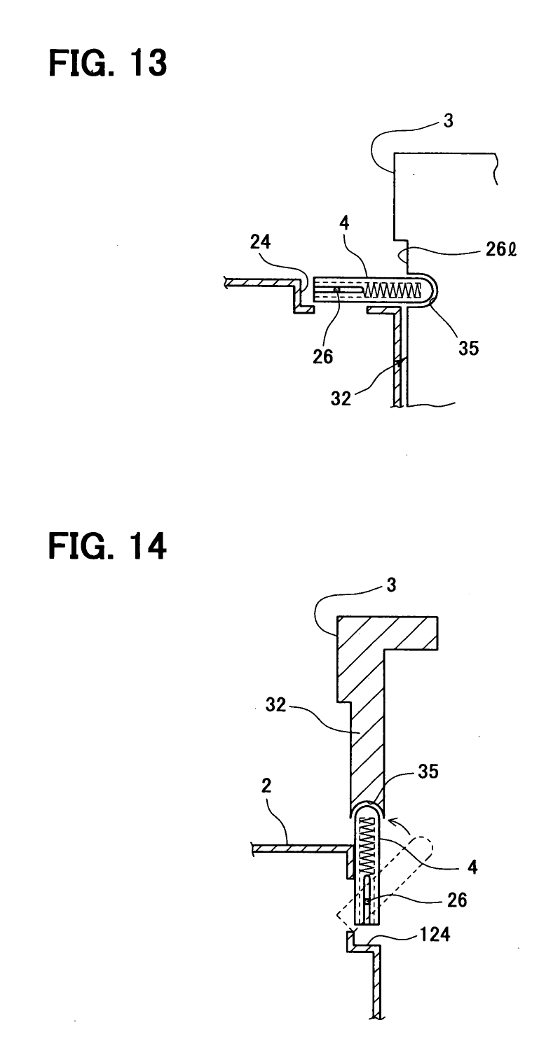

As shown in FIG. 13, it is possible to form a tip end floating regulating portion 261 on the dial knob 3. In FIG. 13, the tip end floating regulating portion 261 is protrusively formed circumferentially of a base end of a stem portion 26.

In addition, as shown in FIG. 14, a click bumpy row 35 is formed on a rear end surface of the dial knob 3 (stem portion 32) to enable the click plunger 4 to engage with the click bumpy row 35 in a manner to make the click plunger advance and retreat in a direction of the axis of rotation of the dial knob 3. In this case, a plunger mount groove 124 is also formed on the housing 2 so that a longitudinal direction agrees with the direction of the axis of rotation.

In addition, the plunger mount grooves 24 (FIGS. 2A, 2B), 124 (FIG. 14) may have groove opened portions thereof dosed by lids after mounting of the click plunger 4.

The dial device is not limited to be applied to a vehicular device. The dial device may be applied to various apparatus.

The above structures of the embodiments can be combined as appropriate.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alterations may be diversely made to the above embodiments without departing from the spirit of the present invention.

What is claimed is:

1. A dial device comprising:
a housing having a mount hole and a recess;
a dial knob rotatable in the mount hole;
a bumpy portion rotatable integrally with the dial knob and has a bumpy row arranged in a circumferential direction of the dial knob;
a plunger being a hollow member having a tip end and a rear end, the tip end being movable in a movable direction so as to engage with the bumpy row in conjunction with rotation of the dial knob when the plunger is in the recess, the rear end defining an opening;
a coil spring accommodated in the plunger; and
a support portion located in the recess at a position corresponding to the rear end of the plunger to abut against a rear end of the coil spring,
wherein the coil spring is compressed between the support portion and an inner surface of the tip end of the plunger to resiliently bias the plunger toward the bumpy row when the plunger is located in the recess, and
at least one of the rear end of the plunger and the recess has a shape such that the plunger is configured to be mounted into the recess without causing an interference between the support portion and the rear end of the plunger in a condition where:
the plunger is imaginary turned around the support portion as a fulcrum in a turning direction having a turning radius, which corresponds to the movable direction of the plunger, within a predetermined plane so as to direct the tip end of the plunger from a first position, in which the tip end is outside the recess, to a second position, in which the tip end is in the recess.

2. The dial device according to claim 1,
wherein the plunger has a guide portion extending from the opening of the rear end of the plunger in the movable direction of the plunger, and
the support portion is configured to engage with the guide portion from the opening to guide the plunger.

3. The dial device according to claim 2,
wherein the support portion has a guide projection projecting from an inner surface, which defines the recess,
the guide portion has a guide notch extending from the opening of the rear end of the plunger toward the tip end of the plunger to reach an intermediate position with respect to a longitudinal direction of the plunger,
the guide projection is inserted from the rear end of the plunger and received by the guide notch, and
the guide notch guides a movement of the plunger in the recess for a predetermined length with respect to the longitudinal direction of the plunger.

4. The dial device according to claim 3,
wherein the guide notch defines a guide slit, which is a through hole extending in a wall portion of the plunger, and
the guide projection has a tip end projecting into the plunger and abutting against the rear end of the coil spring when being inserted into the guide slit.

5. The dial device according to claim 4,
wherein the guide shaft portion extends perpendicularly to the movable direction of the plunger, and
the guide projection has a guide shaft portion, which is configured to be located in the guide slit.

6. The dial device according to claim 5,
wherein the guide shaft portion has an auxiliary shaft portion, which connects the guide shaft portion with a rear end of an inner wall portion defining the recess,
the auxiliary shaft portion extends in a plunger mount clearance with respect to the movable direction of the plunger,
the rear end of the plunger has an auxiliary slit, which is configured to permit the auxiliary shaft portion to pass therethrough, and
the auxiliary slit is positioned to overlap a relative turning locus of the auxiliary shaft portion at the time of the imaginary turning.

7. The dial device according to claim 1,
wherein the housing has a recess rear end wall, which defines a rear end of the recess on a rear side with respect to the movable direction of the plunger, and
the recess rear end wall is positioned rearward of an imaginary locus drawn by the rear end of the plunger in a condition where:
the plunger is retreated against the biasing force of the coil spring over a distance sufficiently to restrict interference between the tip end of the plunger and the bumpy row; and
the plunger is imaginarily turned about a center axis of the guide shaft portion.

8. The dial device according to claim 7,
wherein the recess is one of a through hole and a groove having a recess opening on one side with respect to a depth direction of the recess, the depth direction being perpendicular to the movable direction of the plunger, and
the recess is configured so that an imaginary locus, which is drawn by a rear end edge of the plunger, and a bottom rear portion of the recess are restricted from causing an interference in a condition where:
the tip end of the plunger is retreated in the recess against the biasing force of the coil spring to be out of the bumpy row; and
the plunger is imaginarily turned to a position, in which the longitudinal direction of the plunger agrees with the depth direction of the recess

9. The dial device according to claim 8,
wherein the bumpy row is defined along an outer peripheral surface of the bumpy portion,
the housing has an inner surface defining the recess formed by drawing a molding core from the recess opening of the recess when the housing is molded of resin,
the recess has a length larger than a depth of the recess, and
the inner surface defining the recess is tapered to have an enlarged width in the recess opening.

10. The dial device according to claim 9,
wherein the plunger has a lateral side, which is opposed to the inner surface being tapered to define the recess, the lateral side being steeper than the inner surface, and
the plunger is clearance fitted in the recess.

11. The dial device according to claim 9, wherein the inner surface being tapered to define the recess and the lateral side of the plunger therebetween define a gap, which is reduced in width toward a bottom of the recess.

12. The dial device according to claim 8,
wherein the housing has a cylinder portion, which has an inner peripheral surface defining the mount hole to accommodate the bumpy row,
the housing has a wall portion integrally formed with the cylinder portion,
one of the cylinder portion and the dial knob has a tip end regulating portion, which is configured to restrict the tip end of the plunger from floating from the recess opening in a condition where the tip end of the plunger is biased from the coil spring into the recess to abut against the bumpy row, and
the tip end is configured to be released by compressing to retreat the plunger for a predetermined distance against the biasing force of the coil spring in the recess.

13. The dial device according to claim 12,
wherein the cylinder portion has a through hole portion through which the recess communicates with an interior of the cylinder portion,
the tip end of the plunger is configured to project toward the bumpy row through the through hole portion, and
the through hole portion has an inner periphery as the tip end regulating portion on a side of the recess opening to restrict the tip end of the plunger from floating from the recess opening.

14. The dial device according to claim 8, wherein the recess as a rear end regulating portion is configured to engage with the rear end of the plunger so as to regulate the rear end of the plunger from floating from the recess opening while permitting the plunger to advance and retreat for a predetermined length in the recess.

15. The dial device according to claim 14,
wherein the rear end regulating portion has a recess side engagement, which is configured to detachably engage with the plunger side engagement from the rear end of the plunger, and
the recess side engagement is configured to engage with the rear end of the plunger while permitting the plunger to move for a predetermined length in the recess when being engaged with the plunger side engagement.

16. The dial device according to claim 12,
wherein the recess has a recess bottom portion defined by a flat surface,
the plunger has a plunger bottom portion defined by a flat surface, and
the recess bottom portion and the plunger bottom portion are configured to be tightly in contact with each other.

17. A dial device comprising:
a housing having a mount hole and a recess;
a dial knob rotatable in the mount hole;
a bumpy portion circumferentially extending and rotatable integrally with the dial knob;
a plunger being a bottomed hollow member having a tip end and an opening rear end, the tip end configured to engage with the bumpy portion in conjunction with rotation of the dial knob when the tip end is in the recess;
a coil spring inserted in the opening rear end of the plunger and having a rear end located in the opening rear end of the plunger; and
a support portion located in the recess to support a rear end of the coil spring so as to compress the coil spring to resiliently bias the tip end of the plunger toward the bumpy portion,
wherein the plunger is rotatable around the support portion when the tip end is inserted from an outside of the recess into the recess without causing interference between the support portion with the rear end of the plunger.

18. A method for manufacturing the dial device according to claim 1, the method comprising:
inserting the coil spring into the plunger;
inserting the rear end of the plunger into the recess to abut the support portion against the rear end of the coil spring so as to support the rear end of the coil spring;
turning the plunger into the recess around the support portion as a fulcrum of turning while compressing the coil spring in the plunger with respect to the support portion so as to fit the tip end of the plunger into the recess; and
resiliently restoring the coil spring to engage the tip end with the bumpy row.

19. A method for manufacturing a dial device, the method comprising:
inserting a coil spring into an opening rear end of a plunger to position a rear end of the coil spring in the opening rear end of the plunger;
inserting the rear end of the plunger from an outside of a housing into a recess of the housing to abut the rear end of the coil spring against a support portion, which is located in the recess, so as to support the rear end of the coil spring by the support portion;
turning the plunger around the support portion to insert the plunger into the recess without causing interference between the support portion with the rear end of the plunger while compressing the coil spring in the plunger by urging the plunger toward the support portion; and
inserting a dial knob into a mount hole of the housing to engage a tip end of the plunger with a bumpy portion, which is integrated with the dial knob, through a through hole portion.

20. The method according to claim 19, further comprising:
resiliently restoring the coil spring to protrude the tip end of the plunger through the through hole portion in the housing.

21. A dial device comprising:
a housing molded of resin and having an outer surface, the housing having an inner periphery defining both a mount hole and a recess in the outer surface;
a dial knob rotatable in the mount hole;
a bumpy portion rotatable integrally with the dial knob and having an outer peripheral surface defining a bumpy row;
a plunger having a tip end movable in the recess and configured to engage with the bumpy row in conjunction with rotation of the dial knob; and
a biasing member provided in the recess together with the plunger to resiliently bias the plunger toward the bumpy row,
wherein the housing has an inner surface defining the recess formed by drawing a molding core from the recess opening of the recess when the housing is molded of resin,
the recess has a length larger than a depth of the recess, and
the inner surface defining the recess is tapered to have an enlarged width in the recess opening.

22. The dial device according to claim 21,
wherein the plunger has a lateral side, which is opposed to the inner surface being tapered to define the recess, the lateral side being steeper than the inner surface, and
the plunger is clearance fitted in the recess.

23. The dial device according to claim 21,
wherein the inner surface being tapered to define the recess and a lateral side of the plunger therebetween define a gap, which is reduced in width toward a bottom of the recess.

24. The dial device according to claim 21, further comprising:
a support portion located in the recess at a position corresponding to the rear end of the plunger,
wherein the biasing member is a coil spring,
the plunger is a hollow member having a rear end defining an opening and accommodating the coil spring, and
the coil spring and the plunger are inserted into the recess in a state, in which the support portion is abutted against a rear end of the coil spring to compress the coil spring abutting to an inner surface of the tip end of the plunger.

25. The dial device according to claim 24,
wherein the housing has a cylinder portion, which has an inner peripheral surface defining the mount hole to accommodate the bumpy row,
one of the cylinder portion and the dial knob has a tip end regulating portion, which is configured to restrict the tip end of the plunger from floating from the recess opening in a condition where the tip end of the plunger is biased from the coil spring in the recess to abut against the bumpy row, and
the tip end is configured to be released from the tip end regulating portion by compressing to retreat the plunger for a predetermined distance against the biasing force of the coil spring in the recess.

26. The dial device according to claim 25,
wherein the cylinder portion has a through hole portion through which the recess communicates with an interior of the cylinder portion,
the tip end of the plunger is configured to project toward the bumpy row through the through hole portion, and
the through hole portion has an inner periphery as the tip end regulating portion on the side of the recess opening to restrict the up end of the plunger from floating from the recess opening.

27. The dial device according to claim 21, wherein the tip end regulating portion is located in the recess and configured to engage with the rear end of the plunger while permitting the plunger to advance and retreat for a predetermined length in the recess so as to regulate the rear end side of the plunger from floating from the recess opening.

28. The dial device according to claim 27,
wherein the tip end regulating portion has a recess side engagement, which is configured to detachably engage with a plunger side engagement from the rear end side of the plunger, the plunger side engagement being formed at the rear end of the plunger, and
the recess side engagement is configured to engage with the rear end of the plunger while permitting the plunger to advance and retreat for the predetermined length in the recess when being engaged with the plunger side engagement.

29. The dial device according to claim 28,
wherein the recess side engagement has a guide projection projecting from an inner surface, which define the recess,
the guide portion has a guide notch, which opens in the rear end of the plunger and extends toward the tip end of the plunger to reach an intermediate position with respect to the longitudinal direction of the plunger, and
the guide projection is inserted from the rear end of the plunger and received by the guide notch.

30. The dial device according to claim 29,
wherein the biasing member is a coil spring,
the plunger is a hollow member having a rear end defining an opening and accommodating the coil spring,
the guide notch has a guide slit, which is a through hole extending in a wall portion of the plunger, and
the guide projection as the support portion has a tip end projecting into the plunger through the guide slit and abutting against a rear end of the coil spring accommodated in the plunger.

31. The dial device according to claim 30,
wherein the recess has a width direction, which is perpendicular to both a depth direction of the recess and the movable direction of the plunger,
the guide projection has a guide shaft portion located in the guide slit, and
the guide shaft portion extends in the width direction of the recess.

32. The dial device according to claim 31,
wherein the guide shaft portion has an auxiliary shaft portion, which is located in the recess to connect the guide shaft portion with a rear end of an inner wall portion defining the recess, and
the auxiliary shaft portion extends in the plunger mount clearance with respect to the movable direction of the plunger.

33. The dial device according to claim 25,
wherein the recess has a recess bottom portion defined by a flat surface,
the plunger has a plunger bottom portion defined by a flat surface, and
the recess bottom portion and the plunger bottom portion are configured to be tightly in contact with each other.
